(19) United States
(12) Patent Application Publication
(10) Pub. No.: US 2005/0105449 A1
(43) Pub. Date: May 19, 2005

(54) Optical scanning device

(76) Inventors: Gheorghe Sorin Stan, Eindhoven (NL); Petrus Theodorus Jutte, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/499,622

(22) PCT Filed: Dec. 19, 2002
(86) PCT No.: PCT/IB02/05630

(30) Foreign Application Priority Data
Dec. 24, 2001 (EP) 01205087.8

(51) Int. Cl. G11B 7/00

(52) U.S. Cl. 369/112.16; 369/112.05

(57) ABSTRACT

A scanning optical device includes a number of independently moveable optical heads H1, H2. Radiation generated by a radiation source is split and made incident on the heads H1, H2 simultaneously. The separate radiation beams 35, 36 are generated by splitting a single radiation beam into two orthogonally polarized radiation beams 35, 36. The separate radiation beams are then capable of similar radial areas of the optical record carrier 2 to be read.

This invention relates to an optical scanning device for scanning optical record carriers.

In known optical scanning devices, optical heads scanning the record carrier with multiple radiation beams have been proposed to increase the speed at which the data on the record carrier can be read. The data buffering needed to output a sustained byte stream in such multi-beam optical disk drive requires substantial memory sizes. This is because most optical disks such as CD and DVD store data along a continuous spiral and they are not specifically designed for random access of the data stored. For this reason, it is necessary to store the entire quantity of information read during one disk revolution by several beams in order to reconstruct electronically the continuous spiral.

Instead of multiple radiation beams the use of multiple optical heads has been proposed. In this way more data can be read at higher speeds, thereby improving the data throughput. JP 08-180455A describes an optical scanning device having two optical heads. Only one optical head is operable at any one time, but access times can be reduced by using the heads sequentially. JP 03-192525A describes a device having two optical heads. However, the optical heads and the associated optics and detector array all move during operation of the system. This makes the unit difficult to implement, expensive and bulky.

According to the invention there is provided an optical scanning device for scanning an optical record carrier, the device including radiation source means for generating radiation and optical elements for transmitting the radiation towards the optical record carrier, the elements comprising a plurality of independently moveable optical heads, each optical head being mounted in a separate radial tracking path and each radial tracking path being angularly separated about the centre of the optical record carrier, wherein the device is adapted to supply each of said optical heads simultaneously with radiation from the radiation source means.

In this way, an improved data throughput can be achieved, and similar radial areas of the record carrier can be scanned simultaneously. Furthermore, it is possible to implement such a system to be compatible with existing record carrier formats. implementation is also relatively inexpensive, unlike multiple beam systems, which require substantial redesign of existing systems.

Further objects, advantages and features of the invention will be apparent from the following more particular description of preferred embodiments of the invention, as illustrated in the accompanying drawings, in which:

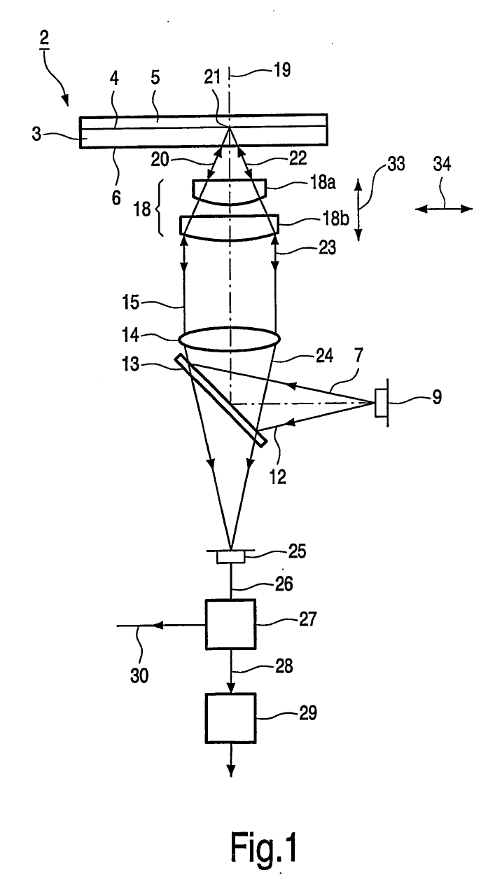

FIG. 1 shows a typical optical scanning device incorporating a single optical head focusing a single radiation beam on a record carrier;

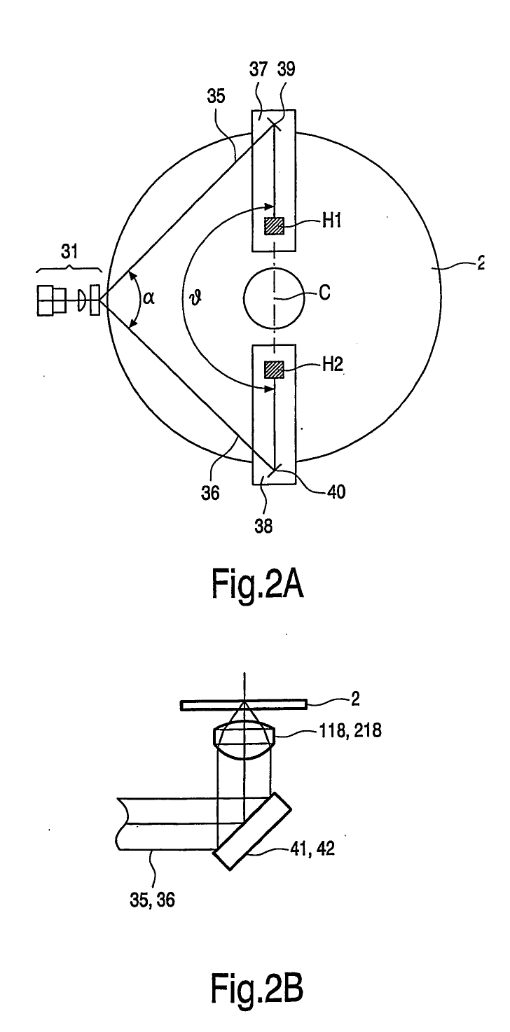

FIG. 2a shows an optical scanning device, in accordance with the invention, incorporating two optical heads, each optical head focusing a radiation beam on the record carrier;

FIG. 2b is a schematic drawing of one of the optical heads of FIG. 2a in accordance with the invention;

FIG. 3 is a schematic drawing of the optical path of the radiation beam in one form of fixed optical arrangement in accordance with the invention, the radiation source being in the plane of the drawing;

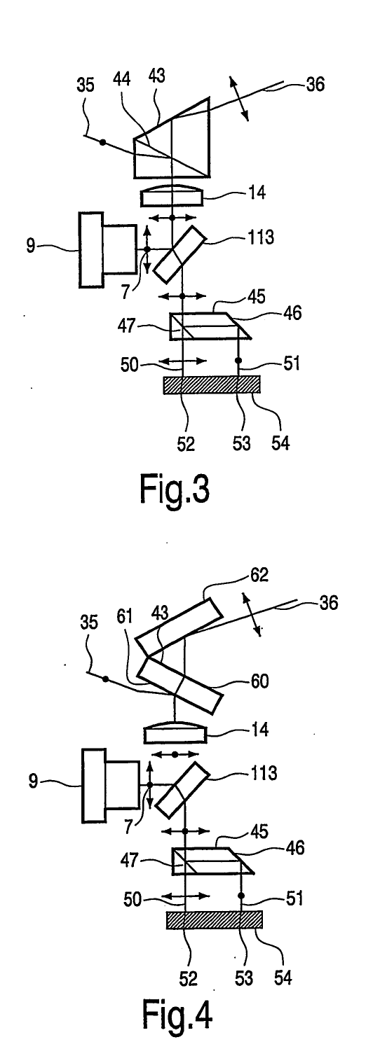

FIG. 4 is a schematic drawing of the optical path of the radiation beam in a further form of fixed optical arrangement in accordance with the invention, the radiation source being in the plane of the drawing;

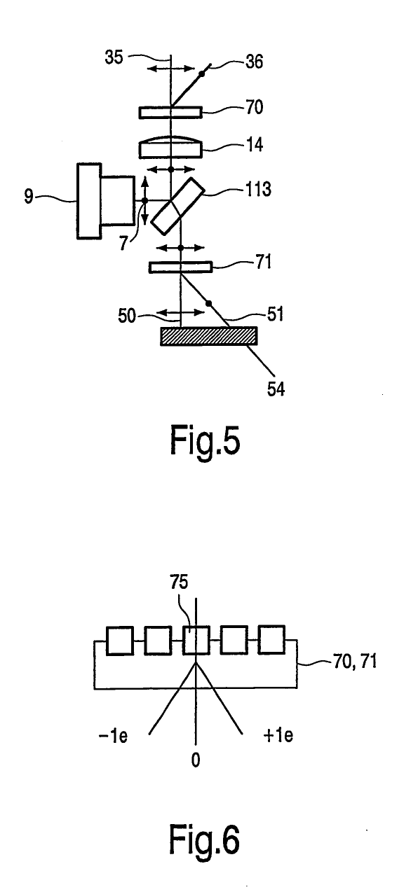

FIG. 5 is a schematic drawing of the optical path of the radiation beam in a further form of fixed optical arrangement in accordance with the invention; and

FIG. 6 shows a polarizing grating used in the arrangement of FIG. 5.

FIG. 1 shows elements of a typical optical scanning device, including an optical head scanning an optical record carrier 2. It is to be noted that the embodiments of the invention, to be described subsequently, include similarly arranged components in each optical beam path. Hence, the description should be taken to apply to the components in each optical beam path of the embodiments of the invention.

The record carrier 2 is in the form of an optical disk comprising a trnsparent layer 3, on one side of which an information layer is arranged. The side of the information layer 4 facing away from the trasparent layer 3 is protected from environmental influences by a protection layer 5. The side of the transparent layer 3 facing the device is called the entrance face 6. The transparent layer 3 acts as a substrate for the record carrier by providing mechanical support for the information layer. Alternatively, the transparent layer may have the sole function of protecting the information layer, while the mechanical support is provided by a layer on the other side of the information layer, for instance by the protection layer 5 or by a further information layer and a transparent layer connected to the information layer 4. Information may be stored in the information layer 4 of the record carrier in the form of optically detectable marks arranged in substantially parallel, concentric or spiral tracks, not indicated in FIG. 1. The marks may be in any optically readable form, e.g. in the form of pits, or areas with a reflection coefficient or a direction of magnetization different from their surroundings, or a combination of these forms.

The scanning device comprises a linearly polarized radiation source in the form of a semiconductor laser 9 emitting a radiation beam 7. The radiation beam is used for scanning the information layer 4 of the optical record carrier 2. A polarizing beam splitter 13 reflects the diverging radiation beam 12 on the optical path towards a collimator lens 14, which converts the diverging beam 12 into a collimated beam 16. The beam 16 is incident on an objective system 18. The objective system may comprise one or more lenses and/or a grating. The objective system 18 in FIG. 1 consists in this example of two elements, a first lens 18a and a second lens 18b arranged between the lens 14 and the position of the record carrier 2. The objective system 18 has an optical axis 19. The objective system 18 changes the beam 16 to a converging beam 20 incident on the entrance face 6 of the record carrier 2. The objective system has a spherical aberration correction characteristic adapted for passage of the radiation beam through the thickness of the transparent layer 3. The converging beam 20 forms a spot 21 on the information layer 4.

Radiation reflected by the information layer 4 forms a diverging beam 22, transformed into a substantially collimated beam 23 by the objective system 18 and subsequently into a converging beam 24 by the collimator lens 14. The beam splitter 13 separates the forward and reflected beams by transmitting at least part of the converging beam 24 towards a detection system 25. The detection system captures the radiation and converts it into electrical output signals 26 which are processed by signal processing circuits 27 and 29 which are located in the scanning device separately from the optical head 1. A signal processor 27 converts these output signals to various other signals.

One of the signals is an information signal 28, the value of which represents information read from the information layer 4. The information signal is processed by an information processing unit for error correction 29. Other signals from the signal processor 27 are the focus error signal and radial error signal 30. The focus error signal represents the axial different in height between the spot 21 and the information layer 4. The radial error signal represents the distance in the plane of the information layer 4 between the spot 21 and the centre of a track in the information layer to be followed by the spot.

The focus error signal and the radial error signal are fed into a servo circuit (not shown) which converts these signals to a focus error signal and a tracking error signal for controlling mechanical focus actuators (not shown) in the optical head. The mechanical focus actuators control the position of the objective system 18 in the focus direction 33, thereby controlling the axial position of the spot 21 such that it coincides substantially with the plane of the information layer 4, and in the radial direction 34, thereby controlling the radial position of the spot 21 such that it coincides substantially with the track currently being scanned. A further mechanical actuator, such as a radially movable arm, alters the position of the optical head 1 in the radial direction 34 of the disk 2, thereby coarsely controlling the radial position of the spot 21 to lie above a track to be followed in the information layer 4. The tracks in the record carrier 2 run in a direction perpendicular to the plane of FIG. 1.

FIG. 2a illustrates the general concept of the invention to be described in more detail below. As can be seen in FIG. 2a, a fixed optical arrangement 31 is arranged to generate two radiation beams 35, 36 which are directed to two independently movable optical heads 39,40, which concurrently form spots on the information layer 4 of the record carrier 2. When leaving the fixed optical arrangement 31, the beams 35, 36 are angularly separated about the exit area. The angular separation α is preferably above 30°, and in the embodiment shown is approximately 90°. The radiation beams 35, 36 are incident on oblique folding mirrors 39, 40 that direct the radiation beams 35,36 toward the respective optical heads H1, H2. Each optical head H1, H2 is independently radially movable by a respective coarse radial tracking unit 37, 38 along a full radial scan of the data-carrying surface of the disk 2. Each coarse radial tracking unit defines a radial tracking path which is angularly separated about the centre C of the record carrier 2. In the embodiment shown, the angular separation θ is 180°. However, other angular separations are also possible. The angular separation is preferably at least above 30°, so that the optical heads do not interfere mechanically when scanning a similar radial area of the record carrier 2. A separation of 180° is preferred in order to reduce the latency when accessing data alternatively with both optical heads.

FIG. 2b illustrates optical components used in each optical head H1, H2. Each optical head includes an objective system 118, 218 mounted in mechanical actuators (not shown) for focus error and tracking error correction. A folding mirror 41, 42 reflects the beams to and from a surface in the record carrier 2.

The two separate radiation beams 35, 36 may be generated by one of several methods to be described below.

Referring first to FIG. 3, the optical scanning device comprises radiation source in the form of a semiconductor laser 9 emitting a radiation beam 7. The radiation source may be substantially unpolarized, or polarized at 45° to the polarizing optics of the polarizing components to be described below. A non-polarizing beam splitter 113 reflects the radiation beam on the optical path towards a collimator lens 14, which converts the beam into a collimated beam. The radiation beam is incident on a prism 43 having a polarizing beam spHtter (PBS) coating 44 that acts to split the beam into the two component radiation beams 35, 36. It should be noted that on exiting the prism 43, the beams 35, 36 are linearly polarized at 90° to each other, as represented in FIG. 3 by the spotted line representing one beam 35 and the arrows in the page marked on the line representing the other beam 36. Similar indications relating to the direction of polarization are given throughout each of FIGS. 3, 4 and 5.

The radiation reflected by the information layer 4 at the two points on the record carrier 2 is transmitted back through the objective lenses 118, 218 and is incident on the mirrors, 41, 42. The reflected beams are then transmitted to the prism 43 whereupon the PBS coating reflects and merges the beams. The merged beam is then incident on the collimator lens 14 and transmitted to the beam splitter 113. The beam splitter 113 separates the forward and reflected beams by transmitting at least a part of the reflected information beam a detector system comprising a micro prism 45 incorporating a PBS coating 47. The PBS coating 47 acts to split the reflected information beam into two beams 50 and 51, the beam 50 representing the information from the region under the lens 118 on the record carrier 2 and the beam 51 representing the information from the region under the lens 218 on the record carrier 2. The beams 50, 51 are polarized at 90 degrees to each other. The radiation beams 50, 51 are then incident on two separate portions 52, 53 of a detector array 54. Respective portions of the detector array 54 produce information signals, focus error signals and radial error signals for the respective areas of the record carrier 2 currently being scanned by the different optical heads.

FIGS. 4 and 5 illustrate alternative methods of producing two radiation beams polarized at 90 degrees to each other. In FIGS. 4 and 5, components are labeled with the same numbers as similar components in the above described system, and descriptions thereof, and of alternatives thereto, will not be repeated but apply here also.

In FIG. 4, the prism 43 is replaced by a PBS coated 60 plate 61 and a plate reflection mirror 62. The combination of these devices acts to produce two radiation beams as described above, each being polarized at 90 degrees to the other.

In FIG. 5, the prism 43 is replaced by polarizing grating 70, which is preferably blazed, acting to split the radiation beam into two component parts, each polarized at 90 degrees to the other. Furthermore, in this example, the micro prism 46 is replaced with a further polarizing grating 71, preferably blazed, that acts on the merged radiation in a similar manner to the micro prism 46, causing the radiation to be split in to its two components representative of the two separate areas on the record carrier 2.

FIG. 6 illustrates the structure of the gratings 70, 71. The grating is made polarizing by the use of grating portions 75 formed of lithium niobium oxide material. However, it will be appreciated that other suitable grating or grating material may be used, such as gratings having suitably low pitch to produce polarizing characteristics. It is also possible to combine the gratings 70, 71 with additional mirrors (not shown) in order to achieve a larger angular separation between the respective outgoing beams.

In operation of the scanning device, the optical heads H1, H2 maybe operated, with the assistance of a scanning control system (not shown), to move the heads independently using the coarse radial tracking units 37, 38 and each to conduct read out from separate data areas at the same time. This improves reading speed when reading out data from a number of separate data areas, as is often the case when the optical record carrier holds a large number of data files stored in such different data areas. When reading out data from a single data area, as for example in the case of audio data when a single data stream is to be produced, the heads can be used to scan different parts of the same data area. For example, a first head may be used to scan a predetermined number of tracks forming a first set of tracks whilst the second head is used, at the same time, to scan the same number of tracks forming a second set of tracks adjacent the first set of tracks, after which the tracking of the first head is jumped to a third area adjacent the second set of tracks and the tracking of the second head is jumped to a fourth area adjacent the third set of tracks, and the two heads continue to read different data at the same time in the third and fourth areas, and so on. In this way, successive parts of the same data area may be read out an increased speed whilst the final data stream is produced by combining the data streams received from the two detector systems corresponding to each head.

In the examples described above, electronic compensation of crosstalk between the channels may be provided in the signal processing stage. Adjustment of the laser for beam angle in two directions perpendicular to the optical axis may be provided after the collimator in the beam path. Furthermore, movable adjustment of the collimator lens along the optical axis may be provided. Additionally, angular adjustment of the mirrors 39, 40 may be provided, to accurately fold the beams towards the moveable optical heads and adjustment around the optical axis of the prism, polarizing plate or polarizing grating above the collimator may be provided in order to reduce crosstalk between the two channels.

The arrangement illustrated may be used to read data out from two parts of the disk simultaneously. Furthermore, the device may also include data writing capability. By using two separate optical paths and lasers, data can be written to two parts of the disk simultaneously.

Thus, the invention provides an optical scanning device that includes two independently moveable optical heads capable of reading two distinct areas of an optical record carrier simultaneously.

The above embodiments are to be understood as illustrative examples of the invention. Further embodiments of the invention are envisaged. For example, instead of splitting radiation from a single radiation source, two separate radiation sources may be used. It is to be understood that any feature described in relation to one embodiment may also be used in other of the embodiments. Furthermore, equivalents and modifications not described above may also be employed without departing from the scope of the invention, which is defined in the accompanying claims.

1. An optical scanning device for scanning an optical record carrier, the device including radiation source means for generating radiation and optical elements for transmitting the radiation towards the optical record carrier, the elements comprising a plurality of independently moveable optical heads, each optical head being mounted in a separate radial tracking path and each radial tracking path being angularly separated about the centre of the optical record carrier, wherein the device is adapted to supply each of said optical heads simultaneously with radiation from the radiation source means.

2. An optical scanning device according to claim 1, wherein said angular separation is at least 30°.

3. An optical scanning device according to claim 2, wherein said angular separation is approximately 180°.

4. An optical scanning device according to claim 1, wherein the optical elements include an optical arrangement for splitting a single radiation beam into at least two component parts, each component part of the beam being incident on a separate optical head.

5. An optical scanning device according to claim 4, in which the optical arrangement is adapted to merge said at least two component parts after reflection from the optical record carrier.

6. An optical scanning device according to claim 4, in which the said optical arrangement comprises a polarizing beam splitter.

7. An optical scanning device according to claim 4, in which the said optical arrangement comprises a polarizing grating.

8. An optical scanning device according to claim 1, the device comprising a detector system for detecting data signals generated by the scanning of the radiation across the optical carrier, in which the detector system provides a plurality of output data streams corresponding to the number of optical heads in the scanning device.

9. An optical scanning device according to claim 8, comprising an optical element disposed between the record carrier and the detector system, the optical element being capable of splitting an incident radiation beam into component parts, and transmitting the component parts to separate parts of the detector.

10. An optical scanning device according to claim 9, in which the said optical element comprises a polarizing beam splitter.

11. An optical scanning device according to claim 9, in which the said optical element comprises a polarizing grating.
